(19) United States
(12) Patent Application Publication
(10) Pub. No.: US 2012/0307498 A1
(43) Pub. Date: Dec. 6, 2012

(54) LIGHT BULB WITH THERMALLY CONDUCTIVE GLASS GLOBE

(76) Inventors: Chung Wai Paul Lo, Hong Kong (CN); Wa Hing Leung, Hong Kong (CN); Tin Po Flavio Chu, Hong Kong (CN)

(21) Appl. No.: 13/484,430

(22) Filed: May 31, 2012

Related U.S. Application Data
(60) Provisional application No. 61/492,862, filed on Jun. 3, 2011.

(51) Int. Cl. F21V 3/00; F21V 29/00

(52) U.S. Cl. 362/249.02

(57) ABSTRACT

An LED lighting device comprises: a base having a socket connector; a housing comprising a primary heat sink, the housing being coupled to the base and having an upper annular rim; a plate having a periphery, at least the periphery of the plate being thermally coupled to the upper annular rim of the housing; at least one LED lighting source, the at least one LED lighting source being thermally coupled to the plate; a globe having a body comprising an outer surface with a light transmittable surface configured to transmit light from the LED lighting source to outside the lighting device; and a secondary heat sink thermally coupled to the plate and the housing, and comprising heat conductors arranged to take the shape of the globe. The housing, plate and secondary heat sink cooperate to conduct heat from the at least one LED lighting source to the surrounding environment.

### CROSS-REFERENCE TO RELATED APPLICATIONS

This application is claims benefit under 35 U.S.C. §119(e) to U.S. Ser. No. 61/492,862, filed Jun. 3, 2011, the entirety of which is incorporated herein by reference.

To the extent that publications are referenced within this application, disclosure of these references in their entirety is hereby incorporated by reference into this application.

### BACKGROUND OF THE INVENTION

The present invention generally relates to improved heat dissipation in lighting apparatuses, such as light emitting diode (“LED”) light bulbs.

Conventionally, LED light bulbs produce a relatively high amount of heat and include a globe section, made for example out of glass, to serve the purposes of transmitting and diffusing the light from the LED elements and preventing a user of the light bulb from touching the LED display itself. To allow for dissipation of heat in LED light bulbs, conventionally there is provided a heat sink forming a lower housing surrounding a base portion of the bulb.

While such a conventional heat sink does dissipate heat, it is bulky and tends to block light from being projected at a downward angle and only provides for heat dissipation at the housing, i.e., lower portion of the bulb, with little heat being dissipated at the top portion of the bulb. Moreover, the LED light bulb's thermal performance mainly depends on the size and design of the housing section, as the globe section has little impact on thermal performance because of the low thermal conductivity of the materials used to make the globe, such as glass or plastic.

Thus, there exists a need for an improved LED lighting device that allows for heat dissipation to occur over a larger area of the device.

### BRIEF SUMMARY OF THE INVENTION

In accordance with a first aspect of the present invention, an LED lighting device comprises: a base having a socket connector; a housing comprising a primary heat sink, the housing being coupled to the base and having an upper annular rim; a plate having a periphery, at least the periphery of the plate being thermally coupled to the upper annular rim of the housing; at least one LED lighting source, the at least one LED lighting source being thermally coupled to the plate; a globe having a body comprising an outer surface with a light transmittable surface configured to transmit light from the LED lighting source to outside the lighting device; and a secondary heat sink thermally coupled to the plate and the housing, and comprising heat conductors arranged to take the shape of the globe. The housing, plate and secondary heat sink cooperate to conduct heat from the at least one LED lighting source to the surrounding environment.

In another aspect, the LED lighting device further comprises a heat conducting medium which is thermally coupled to the at least one LED lighting source and the plate, and wherein the heat conducting medium extends vertically from the plate and substantially perpendicular to the plate.

In another aspect, the housing and the secondary heat sink are made of at least one material with a thermal conductivity higher than 5 W/mK.

In another aspect, the housing and the secondary heat sinks are made of materials selected from a group consisting of aluminum, copper and alloys of aluminum and copper.

In another aspect, the secondary heat sink comprises plural wires within body of the globe.

In another aspect, the plural wires are in a range of about 1 mm to 2 mm in thickness.

In another aspect, the globe comprises plural pieces of glass separated by respective ones of the wires.

In another aspect, each wire has concavities at its edges that are affixed to convexities at edges of the plural pieces of glass to form the globe.

In another aspect, each wire has convexities at its edges that are affixed to concavities at edges of the plural pieces of glass to form the globe.

In another aspect, the wires are arranged in a cross-hatched manner and together form the secondary heat sink having substantially the same shape as the globe.

In another aspect, the wires are oriented vertically and together form the secondary heat sink having substantially the same shape as the globe.

In another aspect, the secondary heat sink extends part of the way to the top of the globe.

In another aspect, the secondary heat sink extends all of the way to the top of the globe.

In another aspect, the secondary heat sink comprises one or more heat pipes.

In another aspect, the globe is a glass globe.

In another aspect, the heating conducting medium is a heat pipe.

In another aspect, the heating conducting medium has a circular, triangular, square or elliptical cross-sectional shape.

### BRIEF DESCRIPTION OF THE DRAWINGS

The figures are for illustration purposes only and are not necessarily drawn to scale. The invention itself, however, may best be understood by reference to the detailed description which follows when taken in conjunction with the accompanying drawings in which:

FIGS. 1A, 1B and 1C are perspective, bottom and cross-sectional views of a lighting device in accordance with a first embodiment of the present invention;

FIGS. 2A, 2B and 2C are side, cross-sectional and magnified views of aspects of the first embodiment of the present invention;

FIG. 2D is a cross-sectional view of a lighting device in accordance with the first embodiment but with the secondary heat sink formed using a cross-hatched configuration;

FIG. 2E is a shallow cross-sectional view of a lighting device in accordance with the first embodiment, with the secondary heat sink formed using a cross-hatched configuration, in which power circuitry in the housing is visible;

FIG. 3 is a cross-sectional view of a lighting device in accordance with the first embodiment, showing heat dissipation in the lighting device;

FIGS. 4A-4F show different configurations for providing the secondary heat sink in accordance with the present invention;

FIG. 5A-7 are views of first, second and third variants of a second embodiment of the present invention;

FIGS. 8-10 are shallow cross-sectional views of a third embodiment of the present invention.

### DETAILED DESCRIPTION OF THE INVENTION

In order to overcome the difficulties of the prior art, the embodiments of the present invention embed thermally conductive material/wire within the globe portion of a lighting device, such as a light bulb. Since thermally conductive materials can carry heat for longer distances than glass, the material typically used for the globe portion, disposing thermally conductive materials in this manner will permit heat generated by lighting elements in the device, such as LEDs, to dissipate from the globe portion of the light bulb as well as from the housing/heat sink lower portion of the light bulb, allow for better overall heat dissipation from the device.

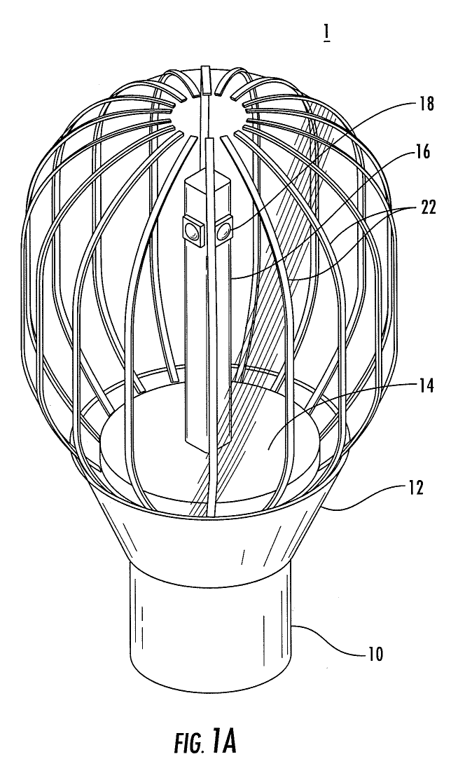

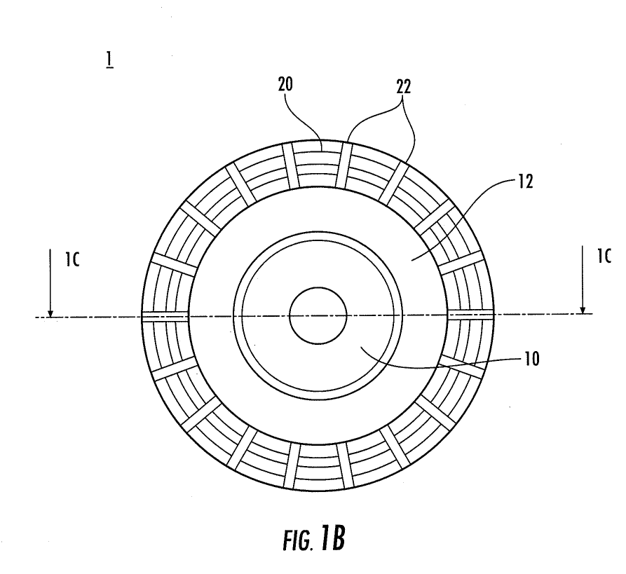

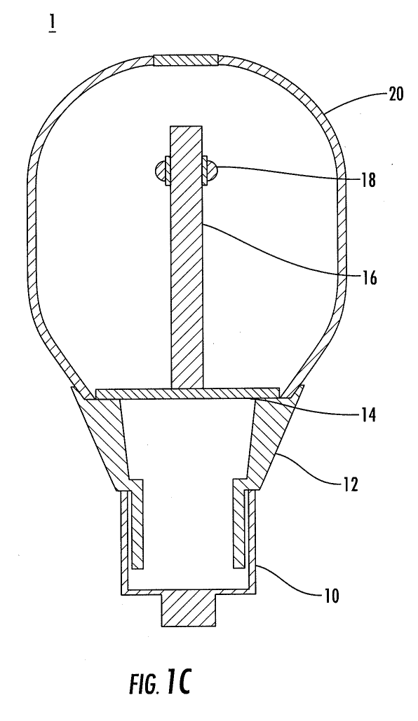

FIGS. 1A-1C are perspective, bottom and cutaway views of an LED light bulb 1 in accordance with a first embodiment of the present invention. As can be seen in the figures, the LED light bulb 1 includes a lampbase 10, which would typically provide connectivity via a wall or ceiling socket for powering the LED light bulb 1. While lampbase 10 is shown in the figures with a relatively smooth shaped connector, the present invention is not limited to the disclosed embodiment and the lamp base 10 can be shaped in the form of a connector having any known configuration, for example a threaded Edison, e.g., E26 or E27, mounting, a double bayonet style mounting, etc., for connection to any of a number of known wall or ceiling sockets known in the art.

A housing 12, serving as a primary heat sink, is provided and mounted into the top of the lampbase 10. The housing 12 is preferably made of a thermally conductive material, such as, for example, aluminum, copper, alloys thereof, or other thermally conductive materials, such as thermally conductive plastics known in the art. The housing 12 can be made of at least one material with a thermal conductivity higher than 5 W/mK.

A thermally conducting plate 14, preferably made of metal or other thermally conductive material, is provided above the housing 12 and rests in contact with a top annular rim of the housing 12, or is thermally connected to the housing 12. In the first embodiment, a heating conducting medium 16, such as a heat pipe, extends vertically from the plate 14 and substantially perpendicular to the plate 14. The heat conducting medium 16 is preferably affixed to the plate 14 by an adhesive, solder, or mechanical structure/contact. In this embodiment, 4 LEDs 18 are mounted at the four respective sides of the heat conducting medium 16 distal to the base of the light bulb 1, but such that the heat conducting medium 16 thermally couples the LEDs 18 to the plate 14. While the heat conducting medium 16 is shown in the illustrated embodiments as having a rectangular cross-section, the shape of the heat conducting medium 16 is not limited to the illustrated example. In accordance with this aspect of the present invention, the heat conducting medium 16 can have other shapes, with other cross-sections, such as circular, triangular, square, elliptical, etc. Also, one or more LEDs can be placed on a side of the heat conducting medium 16.

A globe portion 20, preferably made of glass, forms the top portion of the light bulb 1. The glass globe portion 20 preferably performs, among other things, a light diffusing function, for example by being frosted or otherwise light diffusive. A metal heat conductor 22, forming a secondary heat sink, is provided in association with the glass of the globe, for example disposed to extend vertically from the housing 12 towards the top of the globe portion 20, following the contour of the globe portion 20. The exact manner of the association between the heat conductor 22 and the globe portion 20 will be discussed below.

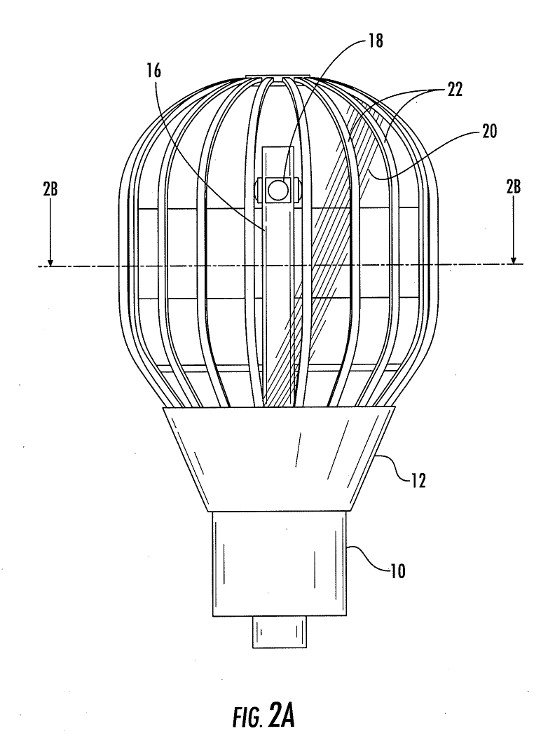

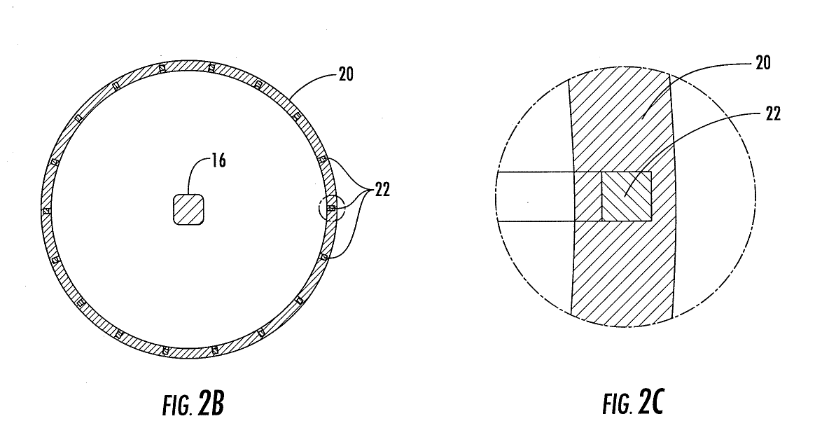

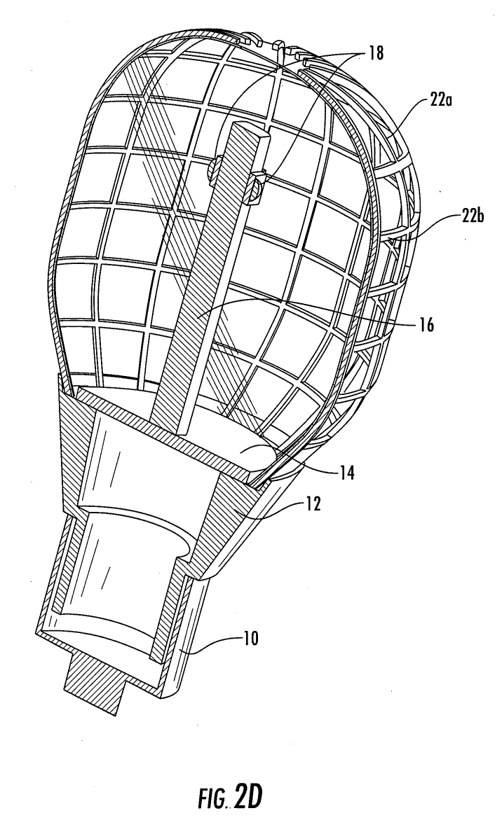

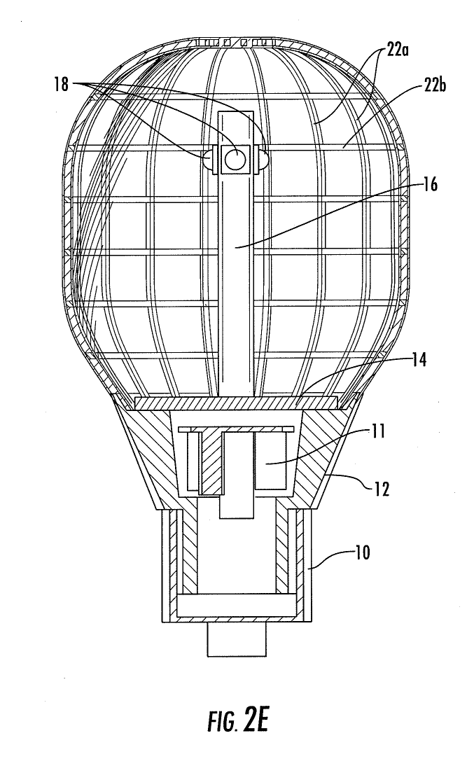

A preferred embodiment showing the location of the secondary heat sink 22 in accordance with a preferred embodiment is next described with reference to FIGS. 2A-2C. As can be seen from the cross-sectional view of FIG. 2B and the magnified detailed portion of FIG. 2C, in a preferred example of the first embodiment, the heat conductor 22 is preferably formed so as to be at least partially located within the glass globe portion 20. As will be discussed in more detail below, the conductor 22 may be fully embedded within the glass globe portion 20, partially embedded within the glass globe portion 20, or situated completely outside, or completely inside the glass globe portion 20. FIG. 2D is a cross-sectional view of a variant of the first embodiment in which the heat conductor 22 is formed of vertical elements 22a and horizontal elements 22b, to form heat conducting elements having a cross-hatched configuration. In the illustrated example, the elements 22a and 22b are generally perpendicular to one another, forming a grid. The cross-hatched configuration is not limited to one in which the elements are perpendicular to one another, nor is this aspect of the invention limited to one in which equal shape/size patches of light transmittable surface are provided by the operation of the elements 22a and 22b. The grid or cross-hatched configuration can provide equal shape/size patches of light transmittable surface on the globe, or different shape/size patches of light transmittable surface.

FIG. 2E is a shallower cross-sectional view of the embodiment shown in FIG. 2D, showing power circuitry 11 embedded within the housing 12. The power circuitry 11 is shown in schematic form as the details do not form a part of the present invention. The power circuitry 11 functions to supply power from the socket to the LEDs 18 and may be implemented in any known manner. It is contemplated that similar power circuitry 11 would be included in the embodiment of FIGS. 1A-2C, although it is not shown in those figures.

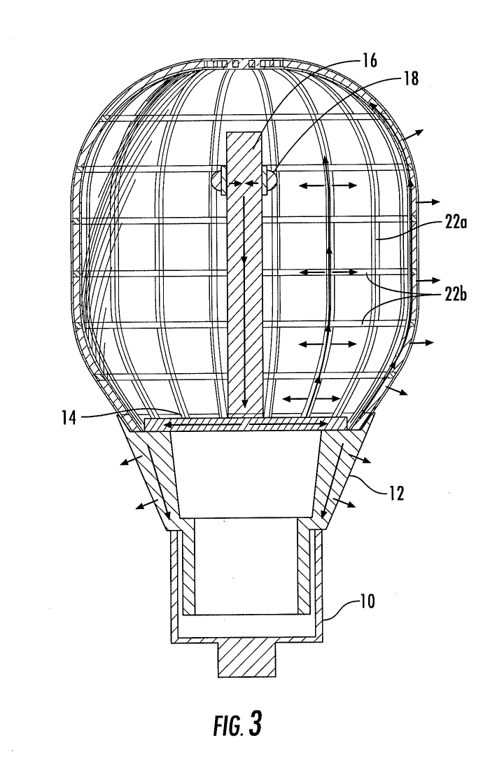

Operation of the heat dissipation of the embodiment of FIGS. 1A-2C will next be discussed with reference to FIG. 3. The LEDs 18 when lit produce a large amount of heat. In the first embodiment, by virtue of the provision of the heat conducting medium 16, the heat produced by the LEDs 18 is conducted down from the LEDs 18 toward the plate 14. The plate 14 is thermally conductive and the heat from the LEDs 18 is then further conducted radially toward the periphery of the plate 14 and into the heatsink formed by the housing 12, on which the plate 14 rests, and to which the plate 14 is thermally coupled, and then outwardly to the external environment, as shown by the arrows. The plate 14 is also in thermal contact with bottom portions of the respective secondary heat sinks 22, such that heat is conducted upwardly through the secondary heat sinks 22 and also out to the environment, as shown by the arrows.

The combination of the heat sink 12 and the secondary heat sink 22 allows for heat to be dissipated not only from the lower portion of the device 1, but also from the globe portion 20 of the device 1, such that heat dissipation is not limited to only the bottom portion of the device. In the case of the light bulb having a grid configuration, as in FIG. 2D, the combination of the vertical and horizontal elements 22a and 22b respectively combine with the heat sink 12 to allow for dissipation of heat.

Although not visible in all of the figures, as will be described below, electrical components, i.e., power circuitry, would typically be provided within the housing 12 and connected to PCB circuitry that supplies power and control to the LEDs.

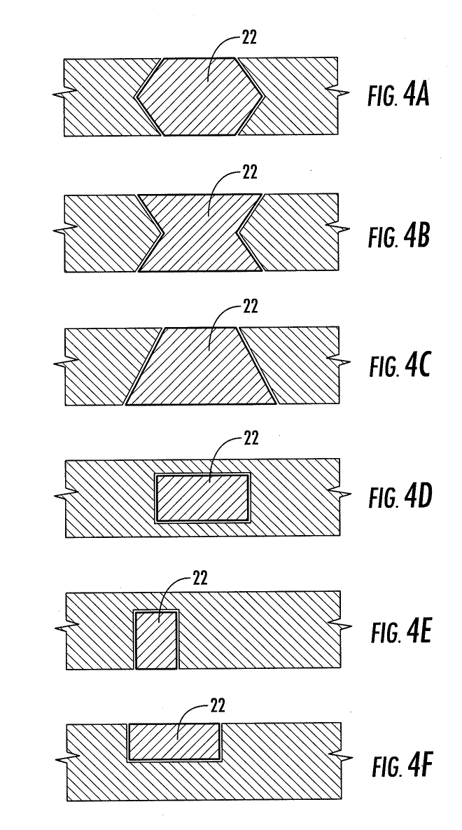

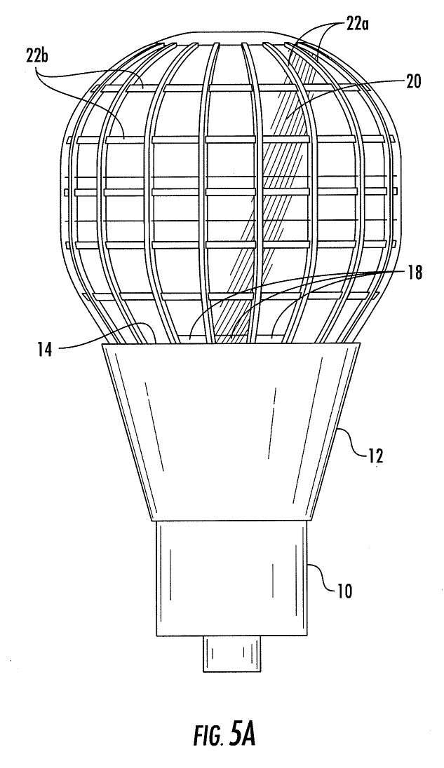

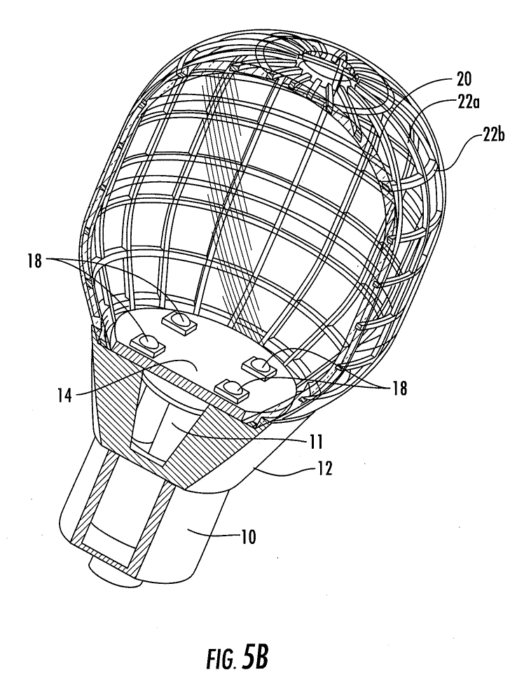

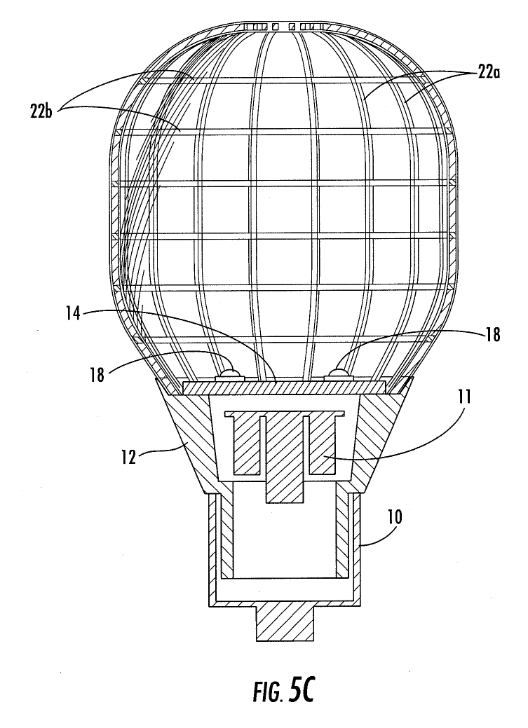

The secondary heat sinks 22 can be configured in a number of ways in relation to the glass of the globe portion 20. For example, a first type of configuration is shown in horizontal cross-sectional view of a portion of the globe at FIG. 4A, in which each heat conductor 22 is located between two pieces of glass, such that the globe consists of a number of separate pieces of glass, each having a beveled concavity which mates with a beveled convexity at each side of the heat conductor 22. In a preferred embodiment, the globe would be held together with an appropriate adhesive affixing the sides of each heat conductor with adjacent pieces of glass.

A second type of configuration, shown in FIG. 4B, like the first type, utilizes separate pieces of glass with heat conductors located between the pieces of glass. However, in the second type, instead of the conductors having convexities at each edge, the conductors have concavities at each edge, which mate with convexities in adjacent pieces of glass, preferably using adhesive.

A third type of configuration, shown in FIG. 4C, like the first and second types, utilizes separate pieces of glass with heat conductors located between the pieces of glass. However, in the third type, instead of the conductors having convexities or concavities at each edge, the conductors are trapezoidal in shape and have angled edge, which mate with adjacent pieces of glass having oppositely angled edges, preferably using adhesive.

A fourth type of configuration, shown in FIG. 4D utilizes conductors 22 that are fully embedded in a glass globe, with the glass globe preferably being formed from a single piece of glass. This configuration avoids the need for adhesive, as the conductors 22 are held in place by being formed within the glass.

A fifth type of configuration also utilizes a globe being formed from a single piece of glass, with the glass having notches on an interior surface of the globe into which the conductors 22 are located. As in the first through third types, adhesive is preferably used to affix the conductors 22 in the glass globe. Alternatively, the conductors 22 may be snap fit on the globe via a pressure fit with the notches.

A sixth type of configuration also utilizes a globe being formed from a single piece of glass, with the glass having notches on an exterior surface of the globe into which the conductors 22 are located. As in the first through third types and fifth types, adhesive is preferably used to affix the conductors 22 in the glass globe. Alternatively, the conductors 22 may be snap fit on the globe via a pressure fit with the notches.

In the first through third types of configuration, the thermally conductive material located between the pieces of glass, in addition to conducting heat, also act as reinforcement for the globe. Preferably, the thermally conductive material is thin, for example within about 1 mm to 2 mm in width, so as not to significantly obscure the light being emitted from the LEDs 18.

Variants of a second embodiment of the light bulb of the present invention are shown in FIGS. 5A-7. Generally, a difference between the first embodiment shown in FIGS. 1A-3 and the second embodiment is that in the second embodiment, the LEDs 18 are directly coupled to the plate 14, rather than indirectly coupled via a heat pipe. The first and second embodiments are the same in all other respects, including the manner of associating the conductors 22 as shown in FIGS. 4A-4F.

In the second embodiment, LEDs 18 are directly thermally coupled to the plate 14, which conducts the heat produced by the LEDs radially towards the periphery of the plate 14, as in the first embodiment. In a variant of the second embodiment, shown in FIGS. 5A-5C the secondary heat sink 22 consists of elements 22a and 22b arranged in a grid configuration, with elements distributed both horizontally and vertically, just as in the first embodiment variant shown in FIG. 2D. FIGS. 5B and 5C show the power circuitry 11, as discussed above, which supplies power from the socket to the LEDs 18 in any known manner of doing so.

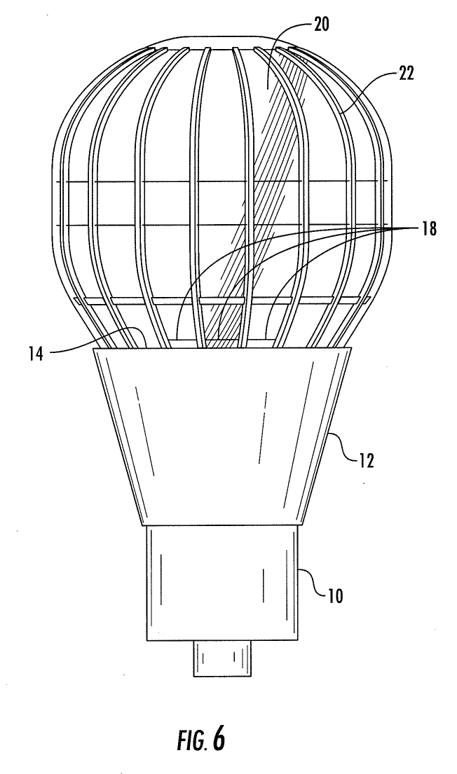

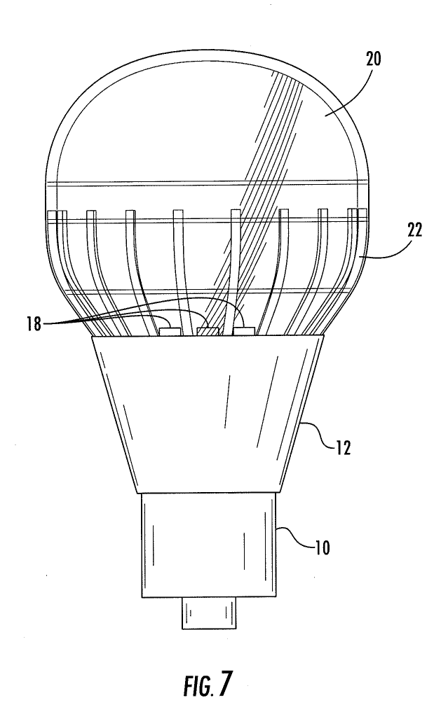

In a second variant of the second embodiment, shown in FIG. 6, again the LEDs 18 are directly thermally coupled to the plate 14, which conducts the heat produced by the LEDs radially towards the periphery of the plate 14. However, in this variant the secondary heat sink consists of only vertical elements 22. In both the first and second variants, the bottom portions of the secondary heat sinks are each thermally coupled to the housing 12, allowing heat to be conducted upwardly around the globe portion of the device.

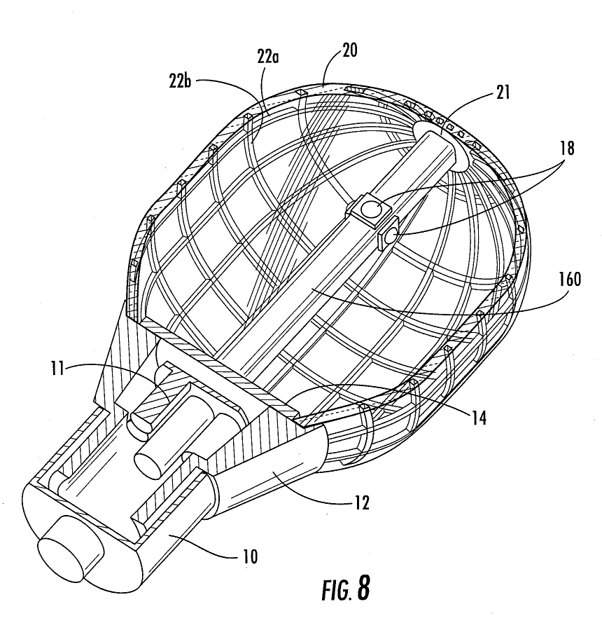

FIG. 7 shows a third variant of the second embodiment. In the second embodiment, in which the LEDs are affixed at a lower portion of the device 1, most of the heat is dissipated at a lower portion of the secondary heat sink 22. That is, the upper portion is relatively cool and does not contribute as much as the lower portion. In view of this finding, and to minimize light obscuration caused by the secondary heat sink 22, the second heat sink can be provided only part of the way up the globe portion 20, while still contributing significantly to dissipation of the heat of the device 1, as shown in FIG. 7.

The use of a copper wire embedded glass globe, in accordance with the disclosed embodiments, can improve overall thermal performance by more that 35%. The exact amount of improved depends upon a number of factors, including the height ratio between the primary heat sink and the glass globe, the density of the network of secondary heat sinks, the thermal conductivity of the secondary heat sinks, and the thickness of the elements of the secondary heat sinks. It should be noted that the various manners of associating the secondary heat sink with the globe shown in FIGS. 4A-4F apply equally to the bulb in and second embodiment as in the first embodiment.

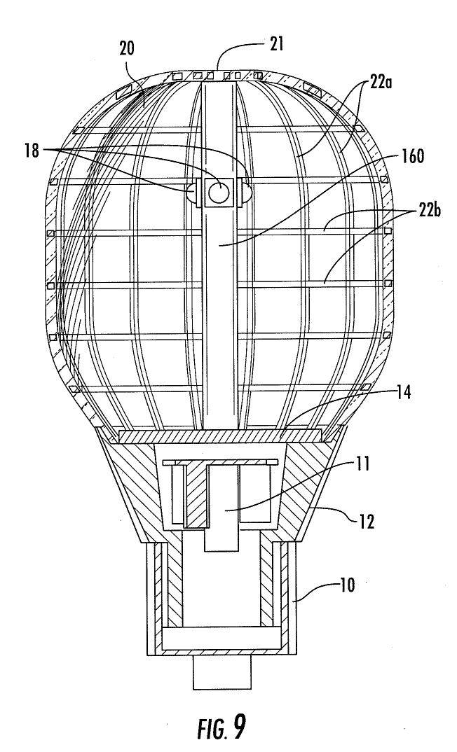

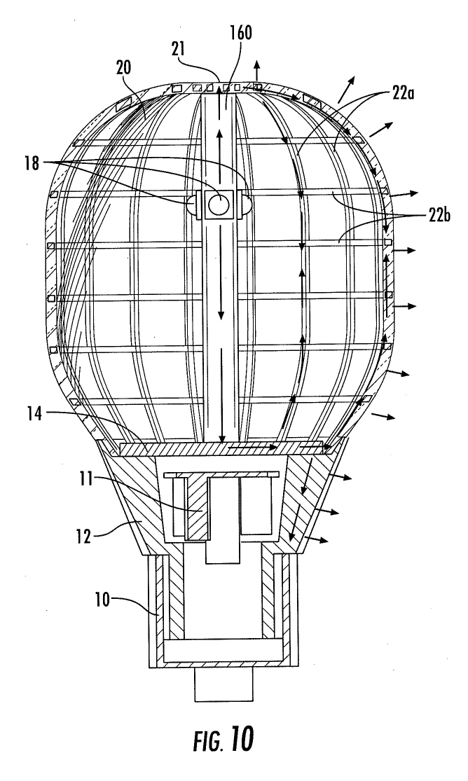

FIGS. 8-10 show a third embodiment of the present invention which, like the first embodiment, uses a secondary heat sink on which the LEDs are mounted. In this embodiment, as shown in the figures, a heat conducting medium (which can be a heat pipe) 160 is provided in a pillar configuration and extends from the plate 14 all the way to the top of the bulb to thermally couple to the top portions of the secondary heat sinks 22a. The heat conducting medium 160 extends vertically from the plate 14 and substantially perpendicular to the plate 14. The bottom of the heat conducting medium 160 is affixed to the plate 14 in the same manner as discussed above with respect to the first embodiment. The top of the heat conducting medium 160 is preferably affixed, in a similar manner, to a cap 21 provided at the top of the bulb 1. The cap 21 is thermally coupled to the endpoints of the vertical secondary heat sinks 22a and to the top of the heating conducting medium 160, for example, by soldering, or by making the secondary heat sinks 22a and the cap 21 out of a single piece of metal.

Just as with the heat conducting medium 16 discussed in relation to the previous embodiments, while the heat conducting medium 160 is shown as having a rectangular cross-section, the shape of the heat conducting medium 160 is not limited to the illustrated example. In accordance with this aspect of the present invention, the heat conducting medium 160 can have other shapes, with other cross-sections, such as circular, triangular, square, elliptical, etc. Also, one or more LEDs can be placed on a side of the heat conducting medium 160.

As shown in FIG. 10, the heat from the LEDs 18 in the third embodiment is carried away from the LEDs 18, both upwardly and downwardly, by the heat conducting medium 160 in the direction of the arrows shown in FIG. 10. The heat is then conducted, again as shown by the arrows, through the plate 14 and out through the housing 12 and the secondary heat sinks 22a and 22b. In this embodiment, heat is also conducted out through the top of the bulb through the cap 21 and down and out from the secondary heat sinks 22a and 22b in the directions of the arrows. The provision of heat flowing both up and down the heat conducting medium 160 allows heat to be distributed more evenly across the globe and further improves overall thermal performance.

While the overall shape of the light bulb is shown in the illustrated embodiments as having a rounded profile, the invention is not limited to this shape. The shape of the bulb can be of any appropriate shape for light bulbs, including but not limited to tubular, cylindrical or rectangular. It is noted that it is preferred that the percentage of the globe portion covered by the secondary heat sink be no more than about 10% of the area of the globe portion, so as to avoid negatively affecting the amount of light from the LEDs. Moreover, while the globe has been described in the preferred configuration as being made of glass, the invention is not limited to using glass. Other materials appropriate for use in light bulbs, such as plastics, could be used as well.

In addition to using secondary heat sinks made of a particular substance, such as metal, the secondary heat sinks in any of the above-described embodiments may also comprise heat pipes, to better conduct heat away from the LEDs, in the manner well known in the art. For example, heat pipes having a cross-section of about 1.5 mm or less could be used for this purpose.

Although specific embodiments have been illustrated and described herein, it will be appreciated by those of ordinary skill in the art that a variety of alternate and/or equivalent implementations may be substituted for the specific embodiments shown and described without departing from the scope of the present invention. For example, any of the above embodiments may utilize a grid or cross-hatched configuration for the secondary heat sinks, or only vertical secondary heat sinks. In addition, variants, such as having the secondary heat sinks cross-hatched diagonally can be utilized. This provisional application is intended to cover any adaptations or variations of the specific embodiments discussed herein. Therefore, it is intended that this invention be limited only by the claims and the equivalents thereof.

What is claimed is:

1. An LED lighting device, comprising:
a base having a socket connector;
a housing comprising a primary heat sink, the housing being coupled to the base and having an upper annular rim;
a plate having a periphery, at least the periphery of the plate being thermally coupled to the upper annular rim of the housing;
at least one LED lighting source, the at least one LED lighting source being thermally coupled to the plate;
a globe having a body comprising an outer surface with a light transmittable surface configured to transmit light from the LED lighting source to outside the lighting device; and
a secondary heat sink thermally coupled to the plate and the housing, and comprising heat conductors arranged to take the shape of the globe,
the housing, plate and secondary heat sink cooperating to conduct heat from the at least one LED lighting source to the surrounding environment.

2. The LED lighting device according to claim 1, further comprising a heat conducting medium which is thermally coupled to the at least one LED lighting source and the plate, and wherein the heat conducting medium extends vertically from the plate and substantially perpendicular to the plate.

3. The LED lighting device according to claim 1, wherein the housing and the secondary heat sink are made of at least one material with a thermal conductivity higher than 5 W/mK.

4. The LED lighting device according to claim 1, wherein the housing and the secondary heat sinks are made of materials selected from a group consisting of aluminum, copper and alloys of aluminum and copper.

5. The LED lighting device according to claim 1, wherein the secondary heat sink comprises plural wires within body of the globe.

6. The LED lighting device according to claim 5, wherein the plural wires are in a range of about 1 mm to 2 mm in thickness.

7. The LED lighting device according to claim 5 or 6, wherein the globe comprises plural pieces of glass separated by respective ones of the wires.

8. The LED lighting device according to claim 7, wherein each wire has concavities at its edges that are affixed to convexities at edges of the plural pieces of glass to form the globe.

9. The LED lighting device according to claim 7, wherein each wire has convexities at its edges that are affixed to concavities at edges of the plural pieces of glass to form the globe.

10. The LED lighting device according to claim 5, wherein the wires are arranged in a cross-hatched manner and together form the secondary heat sink having substantially the same shape as the globe.

11. The LED lighting device according to claim 5, wherein the wires are oriented vertically and together form the secondary heat sink having substantially the same shape as the globe.

12. The LED lighting device according to claim 1, wherein the secondary heat sink extends part of the way to the top of the globe.

13. The LED lighting device according to claim 1, wherein the secondary heat sink extends all of the way to the top of the globe.

14. The LED lighting device according to claim 1, wherein the secondary heat sink comprises one or more heat pipes.

15. The LED lighting device according to claim 1, wherein the globe is a glass globe.

16. The LED lighting device according to claim 2, wherein the heating conducting medium is a heat pipe.

17. The LED lighting device according to claim 2 or 15, wherein the heating conducting medium has a circular, triangular, square or elliptical cross-sectional shape.
